(19) United States
(12) Patent Application Publication
(10) Pub. No.: US 2016/0138667 A1
(43) Pub. Date: May 19, 2016

(54) Micromechanical spring mechanism

(71) Applicant: Robert Bosch GmbH, Stuttgart (DE)

(72) Inventors: Odd-Axel PRUETZ, Nuertingen (DE); Hendrik Specht, Pliezhausen (DE); Antoine Puygrainer, Stuttgart (DE)

(21) Appl. No.: 14/926,235

(22) Filed: Oct. 29, 2015

(30) Foreign Application Priority Data
Nov. 17, 2014 (DE) 10 2014 223 351.8

(51) Int. Cl. F16F 1/18; F16F 1/26

(52) U.S. Cl. CPC F16F 1/18; F16F 1/26; F16F 2226/04; F16F 2230/0047; F16F 2238/022

(57) ABSTRACT

A micromechanical spring mechanism, having two spring legs, which essentially are disposed in parallel with one another; and at least one stop element, which is placed so as to prevent the two spring legs from striking each other.

### RELATED APPLICATION INFORMATION

The present application claims priority to and the benefit of German patent application no. 10 2014 223 351.8, which was filed in Germany on Nov. 17, 2014, the disclosure of which is incorporated herein by reference.

### FIELD OF THE INVENTION

The present invention relates to a micromechanical spring mechanism. Furthermore, the present invention relates to a method for manufacturing such a micromechanical spring mechanism.

### BACKGROUND INFORMATION

Micromechanical inertial sensors, i.e., sensors having movable structures, such as rate of rotation sensors, acceleration sensors or micro mirrors, frequently use micromechanical springs on which seismic masses are suspended. In addition to their mass suspension function, these spring suspensions are also often employed as mechanical stops, in order to decelerate or restrict the movement in the event of an overload, and to thereby prevent the spring from being destroyed, such as fractured, for instance.

Overload cases may arise due to external accelerations or also rotary accelerations. Since each inertial sensor is connected to an electrical evaluation circuit as well, overload cases may also be caused by electrostatic forces, which are generated by externally applied electrical voltages, either intentionally or unintentionally.

Although this approach, that is, the use of a spring suspension as a mechanical stop as well, has been successful in many instances, the fact still remains that any contact between the oscillating structures and firmly attached structures constitutes a certain risk with regard to material erosion.

For example, in a rate-of-rotation sensor having a resonant frequency of a few 10 kHz, a few million strikes may occur within a few minutes as a result of excessive electrical drive voltages.

Apart from a potential particle formation and the attendant risks with regard to electrical and mechanical short-circuits, such a material erosion, for example, may also lead to thinning of mechanically active spring structures and thereby change their mechanical rigidity. In the extreme case, there is also the possibility that the mechanically active spring structures are severed.

FIG. 1a shows a conventional micromechanical spring mechanism 100 having two spring legs 10, which are disposed in parallel with each other; a fixed connection 30 configured from an oxide material; and a movable seismic mass 40. When spring mechanism 100 is operating normally, the two spring legs 10 should never touch, the width of spring legs 10 being selected accordingly.

FIG. 1b indicates by a dash-dotted line a potential area of contact between fixed connection 30 and seismic mass 40, the unintentional collision between fixed connection 30 and movable mass 40 in the contact region being illustrated.

FIG. 1c shows a result of a multitude of such hits; it can be seen that spring legs 10 are much thinner in the region of fixed connection 30 and movable mass 40, on account of particulate matter abrasion, which represents a considerable fracture risk for spring legs 10 and may constitute a considerable reduction in the functionality of spring mechanism 100. This produces mechanically softer spring legs 10, in particular, which may cause a reduction in the drive frequency of spring mechanism 100.

### SUMMARY OF THE INVENTION

Therefore, it is an object of the present invention to provide an improved micromechanical spring mechanism.

According to a first aspect, this objective is achieved by a micromechanical spring mechanism, which includes
two spring legs, which in principle are oriented in parallel with each other; and
at least one stop element, which is situated so as to prevent the two spring legs from striking against each other.

When masses collide, the stop element can advantageously ensure that the spring legs will not be damaged. This provides an effective preventive measure that makes it possible to avoid damage to critical locations of the spring mechanism during a faulty operation that is limited in time.

According to a second aspect, the object is attained by a method for producing a micromechanical spring mechanism, which features the following simultaneously executed steps:
Developing two spring legs which are situated in parallel with each other;
Developing a stop element; and
Placing the stop element in such a way that the spring legs are prevented from striking against each other.

Advantageous further refinements of the micromechanical spring mechanism and the method are the subject matter of the further descriptions herein.

One advantageous further development of the micromechanical spring mechanism is characterized in that a width of the stop element lies in the order of magnitude of a dimension of a head of the spring mechanism. In this way the stop element is specifically dimensioned such that it is possible to prevent the two spring legs from striking each other.

Another advantageous development of the micromechanical spring mechanism is characterized by the fact that the stop element is integrally configured with the spring mechanism. This facilitates a technically uncomplicated production of the stop element, which thus is able to be produced in the same production process as the rest of the spring mechanism.

Another advantageous development of the spring mechanism is characterized by the fact that the stop element is situated outside the region of the spring legs. This makes it possible to prevent damage to the spring legs.

Another advantageous development of the spring mechanism is characterized by the fact that the stop element is situated on a holder for the spring legs. Although this allows the holders of the spring legs to strike against each other and thereby results in some intentional damage to the stop element, this has no effect on the spring legs. If striking occurs, material erosion of the spring legs is thereby avoided for the most part.

In another advantageous further development of the spring mechanism, the stop element is configured to have the largest surface area possible. In this way a force that is acting on the stop element can be made more uniform, so that a number of strikes is able to be maximized.

Another advantageous further development of the spring mechanism is characterized by the fact that a material of the stop element is the same material as a material of the rest of the spring mechanism. This helps in making the stop element processable by time-tested processing methods known from the field of microsystem technology.

In the following text the present invention is described in detail together with additional features and advantages with the aid of a number of figures. All the features are the subject matter of the present invention, independently of their representation in the description and in the figures, and independently of their antecedent references in the claims. The figures are not necessarily shown true to scale and in particular are meant to illustrate the principles of the present invention.

### BRIEF DESCRIPTION OF THE DRAWINGS

FIG. 1a shows a conventional micromechanical spring mechanism.

FIG. 1b shows a conventional micromechanical spring mechanism in a striking situation.

FIG. 1c shows the micromechanical spring mechanism from FIG. 1a and FIG. 1b following many strike events.

FIG. 2a shows a first specific embodiment of a micromechanical spring mechanism.

FIG. 2b shows the micromechanical spring mechanism from FIG. 2a in the strike situation.

FIG. 2c shows the micromechanical spring mechanism from FIG. 2a and FIG. 2b following many strike events.

FIG. 3 shows a basic sequence of one specific embodiment of the method according to the present invention.

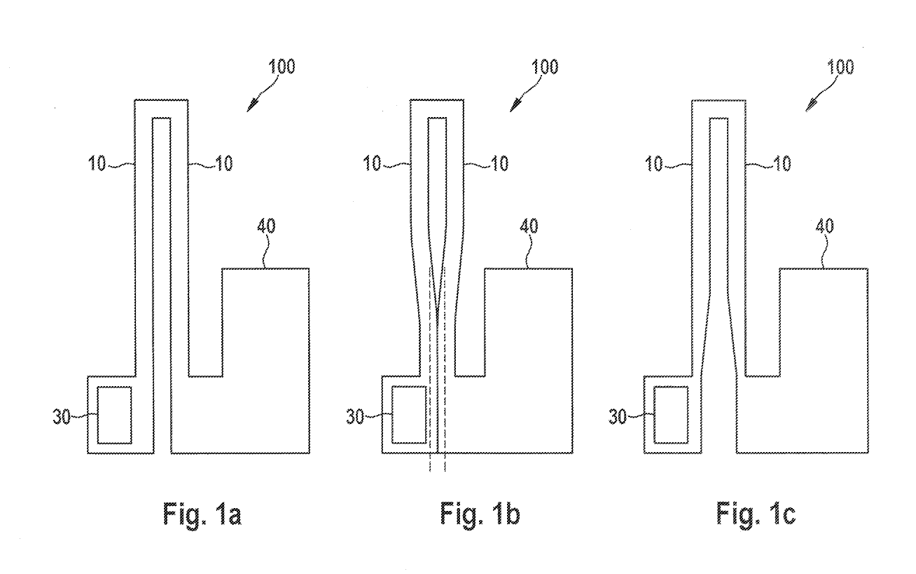

### DETAILED DESCRIPTION

The present invention proposes to use a stop element 20, which realizes a type of wear reserve, in order to constructively protect locations of micromechanical spring mechanism 100 where mechanical contacts may arise in overload situations. In this way the material erosion will initially not lead to a weakening of the spring structures, but merely to an intentional material erosion at locations that are less relevant. Depending on the individual configuration, this makes it possible, for example, to absorb a few thousand up to a few 100,000 strike events, without causing significant weakening of active spring structures.

For the most part, the spring structures are situated at connection points that lie across from the fixed and the movable structures. In the present invention, the particular spots at which spring legs 10 may be contacted are reinforced by a stop element 10 in the form of a stop base or a stop nub or a sacrificial stop structure. This may be done in regions in which movable mass structures that render no contribution to a rigidity of the spring mass system of spring mechanism 100 are located across from each other.

The geometrical dimensions of stop element 20 may be adapted to geometrical dimensions of spring legs 10 that result from a conventional production process (trench and gas phase etching steps) of micromechanical spring mechanism 100. To be mentioned as orders of magnitude in this case are lengths of spring legs 10 of a few 100 μm and a thickness of spring legs 10 of a few micrometers. A thickness of stop element 20 may be adapted to a head dimension d of spring mechanism 100.

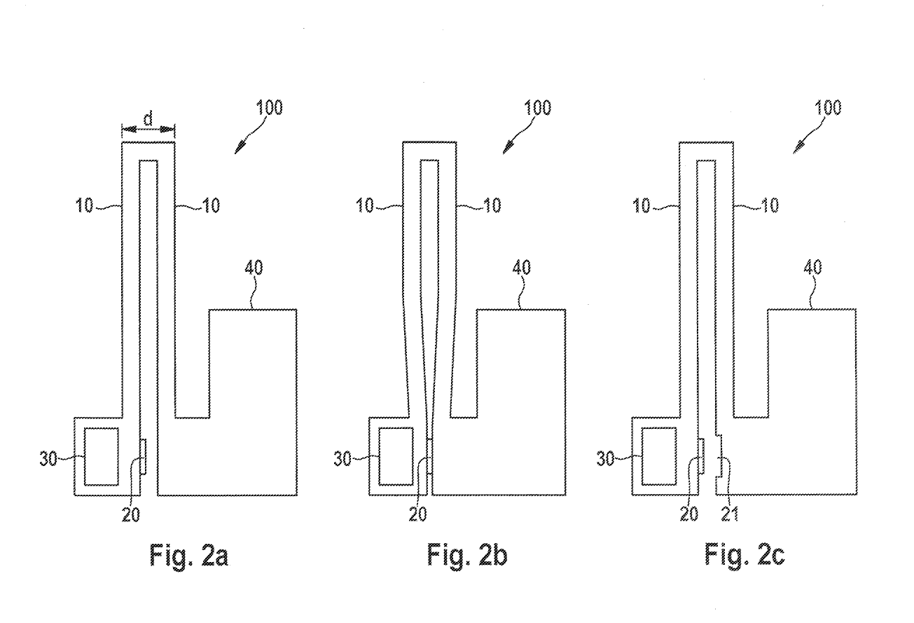

FIG. 2a shows one specific embodiment of a spring mechanism 100 according to the present invention, which includes said stop element 20, which is situated on one side of fixed connection 30. The material of stop element 20 may be the same material as a material of the rest of spring mechanism 100, in particular the same material as spring legs 10 and holder 40 of spring mechanism 100. Stop element 20 may be produced from polycrystalline silicon. Other materials, such as monocrystalline silicon, germanium, etc. are possible as an alternative. It is clear that stop element 20 is situated in a region of fixed connection 30 that lies outside the attachment region of spring legs 10 with the fixed connection or seismic mass 40.

As an alternative, stop element 20 could also be situated in the region of seismic mass 40 in a corresponding position (not illustrated). Stop element 20 may be configured to have the largest surface area possible in order to thereby keep a pressure on an individual surface segment of stop element 20 to a minimum. In one variant, for example, it may be provided that stop element 20 covers the entire potential contact area between fixed connection 30 and seismic mass 40 (not shown).

In this way no mechanical contact takes place in the region of spring legs 10, as fundamentally sketched in FIG. 2b. This means that spring legs 10 no longer make contact, even if striking occurs, so that no material erosion can arise in the region of spring legs 10.

FIG. 2c shows micromechanical spring mechanism 100 after many striking events. It is clear that despite the many hits, spring legs 10 are undamaged and material erosion in the form of a depression or an indentation 21 occurs only in the region of movable mass 40, which, however, constitutes acceptable damage for spring mechanism 100.

Spring mechanism 100 thus is able to compensate for a defined number of fault events; for example, it may also be used for devices that have a very short service life, e.g., sensors for consumer goods with a limited service life.

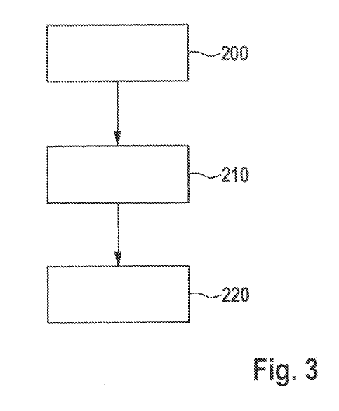

FIG. 3 illustrates, in the form of a flow chart, a principal structure of the method of the present invention in which steps 200 to 220 are executed at the same time. The simultaneity is due to the fact that the steps are executed in a micromechanical manufacturing process in which epitaxy, exposures and etching techniques are employed.

In a step 200, two spring legs 10 are formed, which are situated in parallel with each other.

In a step 210, a stop element 20 is configured.

In a step 220, stop element 20 is placed in a way that prevents spring legs 10 from striking each other.

In summary, the present invention provides a micromechanical spring mechanism and a method for producing such a spring mechanism, by which it is ensured that material erosion takes place at a location that is neutral with regard to a spring rigidity of the micromechanical spring mechanism. That is to say, damage to the spring mechanism is deliberately accepted, such damage, however, advantageously occurring only at locations where it is of no importance for a sensor equipped with the micromechanical spring mechanism.

This advantageously makes it possible to provide protection against a faulty operation or protection against externally induced mechanical overloading, by which a defined number of faulty operations is able to be absorbed.

A geometric extension of stop element 20 is advantageously such that it covers the region of fixed connection 30 in a planar manner. Material erosion can thereby be distributed across the surface, which allows a higher number of striking events.

The micromechanical spring mechanism may advantageously be used for internal sensors in the automotive sector, for example.

Although the present invention has been described in the preceding text on the basis of specific embodiments, it is by no means restricted to these embodiments. One skilled in the art will recognize that many further developments are possible without departing from the core of the invention.

What is claimed is:

1. A micromechanical spring mechanism, comprising:
two spring legs, which essentially are disposed in parallel with one another; and
at least one stop element, which is placed so as to prevent the two spring legs from striking each other.

2. The micromechanical spring mechanism of claim 1, wherein a width of the stop element lies in the order of magnitude of a dimension of a head of the spring mechanism.

3. The micromechanical spring mechanism of claim 1, wherein the stop element is integrally configured with the spring mechanism.

4. The micromechanical spring mechanism of claim 1, wherein the stop element is situated outside a region of the spring legs.

5. The micromechanical spring mechanism of claim 1, wherein the stop element is situated on a holder for the spring legs.

6. The micromechanical spring mechanism of claim 5, wherein the stop element is configured to have the largest surface area possible.

7. The micromechanical spring mechanism of claim 1, wherein a material of the stop element is the same material as a material of the rest of the spring mechanism.

8. A method for producing a micromechanical spring mechanism, the method comprising:
providing two spring legs which are situated in parallel with one another;
providing a stop element; and
placing the stop element so that the spring legs are prevented from striking each other.

9. The method of claim 8, wherein the stop element is situated in a region outside of the spring legs.

10. The method of claim 9, wherein the stop element is situated on a holder of the spring legs.

11. The micromechanical spring mechanism of claim 1, wherein the micromechanical spring mechanism is used in an inertial sensor.
